(19) United States
(12) Patent Application Publication
(10) Pub. No.: US 2003/0182582 A1
(43) Pub. Date: Sep. 25, 2003

(54) Network security simulation system

(76) Inventors: Jong Sou Park, Goyang-Si (KR); Sung-Do Chi, Goyang-Si (KR); Hwan-Kuk Kim, Seoul (KR); Jang-Se Lee, Kunpo-Si (KR); Jeong-Rye Jeong, Seoul (KR)

Correspondence Address: Michael A. Cantor, 55 Griffin South Road, Bloomfield, CT, 06002, US

(21) Appl. No.: 10/390,847

(22) Filed: Mar. 18, 2003

(30) Foreign Application Priority Data
Mar. 19, 2002 (KR) 2002-14855

(51) Int. Cl. H04L 9/00

(52) U.S. Cl. 713/201

(57) ABSTRACT

A network security simulation system. The network security simulation system is capable of analyzing a hacking procedure through a simulation on a network. The network security simulation system is based on a component model base which librarizes each component of a network system as an object. The network system which is an analysis target can be freely designed based on the library. At least one attacker node and at least one target node are set in the designed network system. Hacking commands are transmitted from the attacker node to a target node through various components of the network system to change a state of the target node. The changed target node state is analyzed by a result analysis unit and then provided to a user.

### BACKGROUND OF THE INVENTION

1. Field of the Invention

The present invention relates to a simulation system, and more particularly to a hacking simulation system which is capable of analyzing a hacking procedure using a simulation on a network.

2. Description of the Related Art

With the current in drive to improve informatization, a social infrastructure has been automatically operated using telecommunication-based technologies, and its reliance on information systems and networks is growing. This infrastructure has a significant effect on economy and security of a country. Especially, it is very important to protect an information infrastructure from a threat such as a hacking or cyber terror. It is urgently required for a country, public institution or company who possesses, operate and manage the information infrastructure to make an effort to protect its information infrastructure.

To protect the information infrastructure, there have been necessarily performed vulnerability evaluation of complex major information infrastructures, analysis of a damage ripple effect and evaluation of appropriate security measures and the like. Conventionally, these tests for protection of the information infrastructure are executed with respect to a real physical infrastructure. In this case, there are many problems of costs, time and responsibility of the tests with respect to the real physical infrastructure.

Recently, there has been an effort to overcome the problems using a simulation. Fred Cohen pointed out there are limitations in accuracy of model and data and in enormity of simulation space in the case of performing modeling and simulation associated with security (Simulating Cyber Attacks Defenses, and Consequences, 1999 IEEE Symposium on Security and Privacy Special 20th Anniversary Program, The Claremont Resort Berkeley, Calif., May 9-12, 1999). Fred Cohen suggested in this paper a simple network security model which is composed of network model represented by node and link, cause-effect model, characteristic functions, and pseudo-random number generator. However, cyber attack and defense representation based on the cause-effect model is so simple that its practical application is limited.

As another conventional technology, Edward Amoroso suggested a method for representing an intrusion model as a result of a study of an intrusion detection model (Intrusion Detection, AT&T Laboratory, Intrusion Net Books, January, 1999). However, the intrusion model representation according to the conventional technology centers around security mechanisms. There has been inadequate study of simulation analysis and utilization in the above conventional technology.

Nong Ye and Joseph Giordano abstracted a complex cyber attack model and suggested a functional level of modeling (CACS—A Process Control Approach to Cyber Attack Detection, Communications of the ACM). However, they failed to provide practical modeling and simulation techniques. On the other hand, in the case of telecommunication-based system modeling tools, which are generally used, modeling is performed through a current analytical method rather than through a system theoretical modeling method, resulting in limitations in representation of an information infrastructure, which tends to be complex, various and large-scaled.

### SUMMARY OF THE INVENTION

Therefore, the present invention has been made in view of the above problems, and it is an object of the present invention to provide a network security simulation system which is capable of thoroughly analyzing a cyber attack in complex, large-scale and varied information infrastructures in consideration of security elements.

It is another object of the present invention to provide network security simulation system which allows free design or modification of an information infrastructure which is an analysis target.

In accordance with one aspect of the present invention, the above and other objects can be accomplished by the provision of a network security simulation system which is based on a component model base which librarizes each component of a network system as an object. The network system which is an analysis target can be freely designed based on the library. The design can be either based on an existing system or based on a system to be implemented in future.

In accordance with another aspect of the present invention, there is provided a network security simulation system in which at least one attacker node and at least one target node are set in a designed network system. Hacking commands are transmitted from the attacker node to a target node through various components of the network system to change a state of the target node.

The changed target node state is analyzed by a result analysis unit and then provided to a user.

In accordance with yet another aspect of the present invention, there is provided network security simulation system comprising a component model base for representing network components by means of a system entity structure representing a structure of a system and a model base indicating behavioral characteristics of the system and librarizing the network components as model objects; a network configuration unit for selecting network components from the component model base according to user's selection and configuring a target network, assigning properties to the selected network components, and setting at least one network component of the network components to be an attacker node and at least one different network component of the network components to be a target node; a command input unit for inputting hacking commands to the attacker node, the hacking commands being assigned to the attacker node; a simulation engine for sending the commands from the command input unit through a network generated by a simulation model generation unit to a set target model according to each component, determining whether to execute the commands, and changing properties of the model according to an execution result; a result analysis unit for displaying a result of the simulation of the simulation engine; and a graphical user interface (GUI) for receiving inputs from a user and displaying a result according to the inputs.

Security characteristics of the network components are modeled and structured to be stored in a library. It is possible to structurally represent a complex and large-scale network system using the library.

Further, the hacking commands are transmitted from the attacker node to a target node in the form of packets through the network to change the state of the target node. Each network node may either send or not send corresponding commands according to modeled characteristics. The hacking commands may either have fatal effects on the target node or be rejected to be executed according to the modeled characteristics of the target node.

Preferably, the command input unit may include an attack scenario database for storing hacking scenarios, each of the hacking scenarios being a collection of hacking commands. Preferably, the hacking commands may be provided to command input unit from a selected hacking scenario in the attack scenario database. Even a beginner with poor hacking technique can understand the entire hacking procedure through the hacking scenarios and be of help in evaluation and design of a network system.

Preferably, the command input unit is implemented with a command prompt window for inputting the hacking commands from a user.

The user can enter the commands to the target node through the command prompt window. Further, the user can check through the result analysis unit how the commands affect the target node at every step.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram schematically showing the construction of a network security simulation system according to an embodiment of the present invention;

FIG. 2 is a block diagram showing an integrated structure consisting of network components according to an embodiment of the present invention; and

FIG. 3 is a view illustrating an example of a sample network.

### DESCRIPTION OF THE PREFERRED EMBODIMENTS

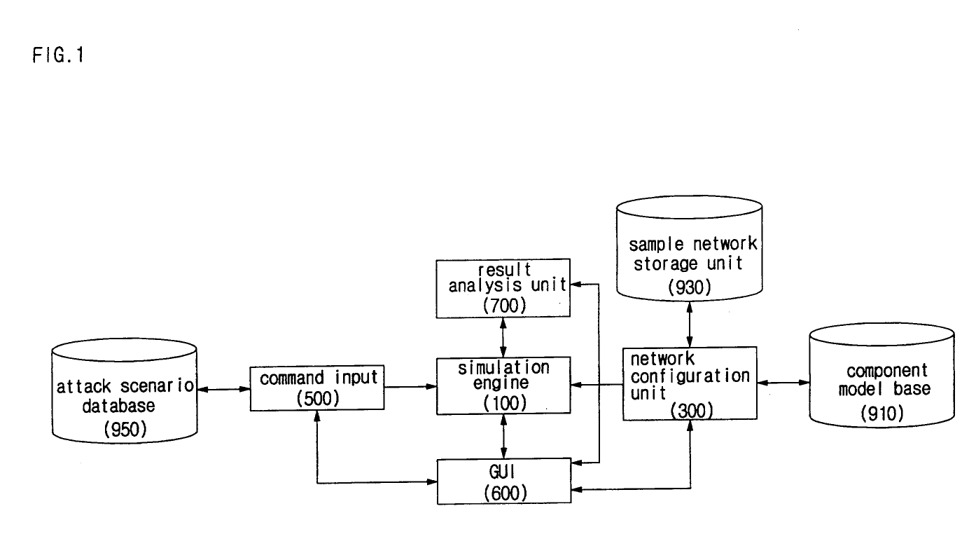

FIG. 1 is a block diagram schematically showing the construction of a network security simulation system according to an embodiment of the present invention.

As shown FIG. 1, the network security simulation system comprises a command input unit 500, network configuration unit 300, simulation engine 100, result analysis unit 700 and graphical user interface (GUI) 600. The command input unit 500 functions to input hacking commands. The network configuration unit 300 functions to configure a target network. The simulation engine 100 functions to execute a simulation by sending commands through the target network. The result analysis unit 700 functions to analyze a simulation result. The GUI 600 functions to graphically present procedures of controlling components, or the command input, network configuration, simulation engine and result analysis units 500, 300, 100 and 700, to a user. Further, the GUI 600 functions to process inputs and outputs.

First, a detailed explain is given of the network configuration unit 300. The network configuration unit 300 exchanges information with the GUI 600 to configure the target network. The user can configure any network and set respective properties of components of the configured network using a graphic edition function of the GUI 600. This procedure is similar to one performed using a computer-aided design (CAD) system. Each of the components is stored in a library in a component model base 910.

According to the present invention, network components are basically represented through a system entity structure (SES) and a model base (MB). B. P. Zeigler proposed SES/MB framework (Multifacetted Modeling and Discrete Event Simulation, Academic Press, 1984). The SES/MB framework enables structural and dynamical representations of a system to be constructed. The SES/MB framework enables a system modeling in which a dynamic-based methodology is systemically integrated with a symbolic methodology of article intelligence (AI).

The SES represents knowledge about system structure in a specific form. This SES is a declarative knowledge representation and defines tree-structured hierarchical models. In order to represent a system, the SES includes three types of nodes, that is, entity, aspect and specialization. The entity corresponds to a real object. The aspect is a mode showing a decomposition characteristic of the entity. The specification is a mode showing taxonomy characteristics of the entity.

The MB having a procedural characteristic shows a behavioral characteristics of a system and consists of models providing dynamic and symbolic representation means. In MB environments, a discrete event model is represented by a discrete-event system specification (DEVS) model, which is a typical formalism for modeling the discrete event. The discrete event model has time base, inputs, states, outputs and functions. The functions decide next states and outputs on the basis of current states and inputs.

In the SES/MB framework, a hierarchical simulation model can be constructed by integrating the system structure with dynamic models which are stored in the MB by applying transformation to the SES having a coupling relation. The present invention employing the SES/MB framework is advantageous in that it is easy to hierarchically design a system and to reuse and implement a model due to an object-oriented design.

The component model base 910 in FIG. 1 stores librarized network components designed in the above manner. The components are structured models based on structured knowledge such as structured relation of the system, types of the components, coupling structure of the components, constraints, etc.

For example, hosts are classified and defined according to a node type, H/W information, OS information, defense type, power state and so forth. The node type is about whether a corresponding node is, for example, a processing node or a routing node. The H/W information is about whether corresponding equipment is, for example, an HP machine, SUN machine or an Inter-based server. The OS information is about whether a corresponding operating system (OS) is, for example, Linux-based or Window-NT-based. The power state is about a state of power ON or OFF.

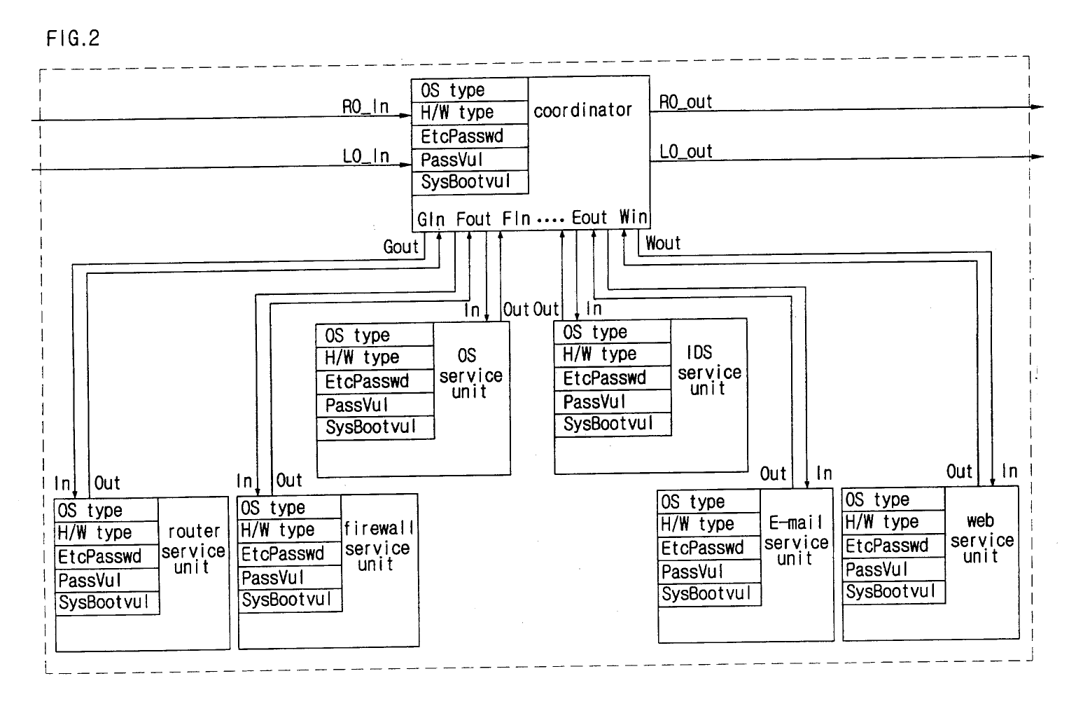

FIG. 2 is a block diagram showing a structure consisting of network components to which the above standard of classification can be applied. Various network components on a given network are respectively represented as process nodes of the same form according to a preferred embodiment of the present invention, so that various functions of the network components are respectively modeled as service models.

Each of the process nodes represents several services as models of the same form, so as to provide the same form with respect to various models. Because it is possible that the entire network components are represented as the process nodes of the same form, there is an advantage in that various network components are can be represented by performing only an addition or deletion of a service provided by each node. Each of the process nodes has several state variables such as an OS type, H/W type, address, account list, system file and vulnerability of a corresponding component. Each of the state variables is changed during service execution to indicate a current state of each component. The component vulnerability signifies vulnerability due to a software bug and a system state set by a manager.

The above structure of FIG. 2 includes all process nodes which can be classified. In detail, the structure of FIG. 2 includes a routing service unit for distributing network packets, an OS service unit associated with a host service maintaining an operating system, an invader sensing service unit associated with an invasion sensing function, a Web service unit, an E-mail service unit, and a coordinator for coordinating the entire processes through inputs to and output from each of the service units.

It is noted that the above structure is an example, and the present invention is not limited to this. It is possible to include new blocks according to a new function classification. Further, a different structure from the described one can be used in the present invention.

The following is an example of coding with respect to each component model.

State variable

Service_type, H/W_type, O/S_type
Registered_User_list, Queue_size, etc.

External transition function

Case input_port

‘in’ : case phase

passive : execute command-table

hold-in busy processing-time

else : continue

internal transition function

case phase

busy : passive

output function

case phase

busy : send packet (result) to port_out

This structured model and dynamic model obtained from various cyber attack scenario data are integrated to generate a simulation model. The component model base 910 stores the structured model (SES) and the dynamic model (MB) in such a way as to match one with the other. The structured model (SES) is integrated with the dynamic model (MB) according to the control of the simulation engine 100.

The network configuration unit 300 acts to determine the structured model. The user defines this coupling relation of the model in the procedure of calling and integrating the component from the library. The defined coupling relation of the model can be temporarily stored or permanently stored in a sample network storage unit 930 in FIG. 1. A sample network previously generated by the user or system manufacturer is stored in the sample network storage unit 930. The sample network provides the user with the target network instead of the network configuration unit 300 without a separate design procedure.

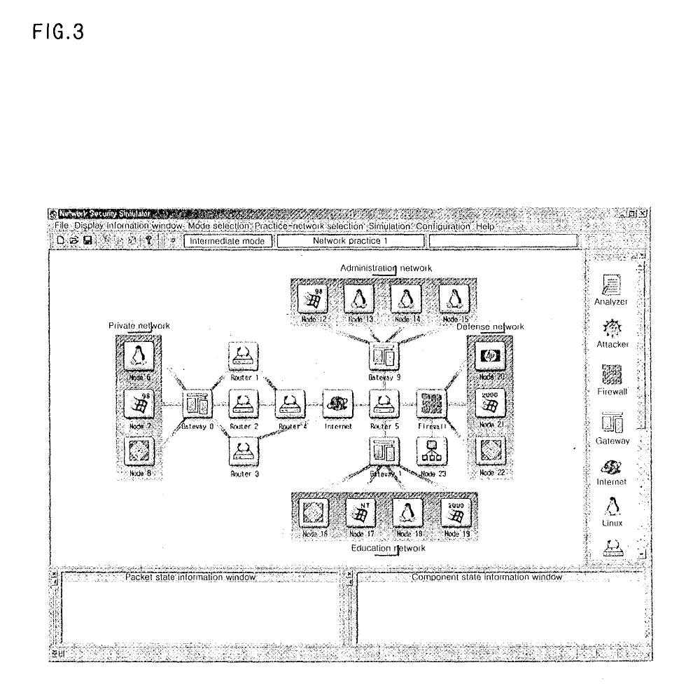

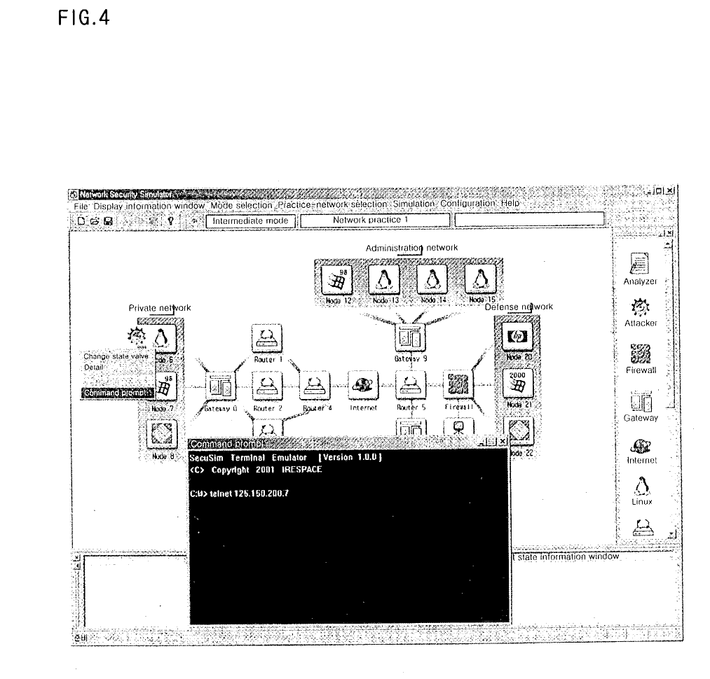

FIG. 3 is a view illustrating an example of the sample network. As shown in this drawing, each component is expressed in an icon on window through the GUI 600. Each node is a processing node and includes hosts, a gateway for the connection of heterogeneous networks, a router for distributing packets, a firewall for security and a LAN for providing a packet communication path between nodes.

If the target network is designed, or decided from the sample network, at least one attacker node and at least one target node are selected among the components on the target network. The selected attacker node is connected to the command input unit 500. The following is an example of a program coding for the attacker node.

State variables

Scenario_type, target_host
Registered_User_list, Queue_size, etc.

External transition function

case input_port

‘in’ : case phase

passive : next command scenario-

table

hold-in active attacking-

time

else : continue

internal transition function

case phase

busy : passive

output function

case phase

active : send packet (result) to port_out

The command input 500 provides hacking commands to the simulation engine 100. A state of each component can be changed using the hacking commands. The hacking commands are configured to be an attack scenario and stored in an attack scenario database 950 in FIG. 1 according to an embodiment of the present invention. The attack scenario may be generated by the user or be previously generated and stored by a system manufacturer. The stored and provided attack scenario helps a beginner understand the entire hacking procedure.

Attack scenarios are classified according to type and stored for the beginner. It is possible to provide information about the nature of each attack scenario, for example, attack type, destructibility and destruction effect.

The command input unit 500 may have a form of a command prompt window. FIG. 4 shows an example of an implementation of the command input unit 500. The user can select an attacker node and a command prompt by clicking on a window with the left button of a mouse. Then, the user can simulate a hacking command execution procedure. Hacking commands which can be entered are determined according to the OS type of the selected attacker node. OS service commands can change states of the target nodes according to the OS types, respectively. The following table shows an example of modeling of these commands.

TABLE 1

| Command | Pre-condition | Output | Post-condition |
|---|---|---|---|
| more | | Output file list | |
| pwd | Check working | Output current | |
| | directory | working directory | |
| rmdir | Check directory | Remove directory | Change directory |
| | | | attributes |
| cd | Check existence or | Move and Change | Change directory |
| | not of the | directory | attributes |
| | directory | | |
| vi | Check existence or | Edit file | Change file |
| | not of the file | | attributes |
| mv | Check existence or | Change file name | Change file |
| | not of the file | | attributes |
| rm | Check existence or | Delete file | Change file |
| | not of file | | attributes |
| chmod | Check the file | Change permission | Change file |
| | existence | mode | possession |

In the above table, the pre-condition represents the condition for executing the command, output represents the results by command execution, and post-condition represents the changed nodes or service properties after command execution.

In order to perform a simulation, the simulation engine transfers hacking command packets to the network component model and changes a state the model according to the result of command execution. The result of the simulation is analyzed by the result analysis unit 700 and then provided to the user through the GUI 600. The result analysis unit 700 performs statistical analysis with respect to the execution result to analyze performance index such as vulnerability of each component on the network. For this, the result analysis unit 700 stores commands from each component to a result table. Outputs from the result analysis unit 700 can include a state history or final state of a passed node as well as the target node. The vulnerability of the target node can be evaluated on the basis of a power state of the target node, a user account list state, presence or not of file damage, a memory state and so forth. The result analysis unit analyzes changes of these states through hacking.

As apparent from the above description, the present invention provides a network security simulation system wherein it is possible to hierarchically design a complex and various network according to a unified standard. Further, the network security simulation system according to the present invention allows a beginner to easily understand the entire hacking procedure and network security through a graphical screen and date using a sample network and sample hacking scenario which both are stored therein. Therefore, the network security simulation system according to the present invention can be utilized for the education of a network engineer. Further, the network security simulation system can be utilized in evaluating and studying vulnerability of security in a design of a large-scale network system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A network security simulation system comprising:
a component model base for representing network components by means of a system entity structure representing a structure of a system and a model base indicating behavioral characteristics of the system and librarizing the network components as model objects;
a network configuration unit for selecting network components from the component model base according to user's selection and configuring a target network, assigning properties to the selected network components, and setting at least one network component of the network components to be an attacker node and at least one different network component of the network components to be a target node;
a command input unit for inputting hacking commands to the attacker node, the hacking commands being assigned to the attacker node;
a simulation engine for sending the commands from the command input unit through a network generated by a simulation model generation unit to a set target model according to each component, determining whether to execute the commands, and changing properties of the model according to an execution result;
a result analysis unit for displaying a result of the simulation of the simulation engine; and
a graphical user interface (GUI) for receiving inputs from a user and displaying a result according to the inputs.

2. The network security simulation system as set forth in claim 1, wherein the command input unit includes an attack scenario database for storing hacking scenarios, each the hacking scenarios being a collection of hacking commands, and wherein the hacking commands are provided therewith from a selected hacking scenario in the attack scenario database.

3. The network security simulation system as set forth in claim 1, wherein the command input unit is implemented with a command prompt window for inputting the hacking commands from the user.

4. The network security simulation system as set forth in any one of claims 1 to 3, wherein the component model base represents various network components as process models of the same form.

5. The network security simulation system as set forth in 4, wherein the component model base includes:
a routing service unit for distributing network packets;
an OS service unit associated with a host service for maintaining an operating system, an invader sensing service associated with an invasion sensing function, a Web service unit, an E-mail service unit and a service coordinator for coordinating the entire processes through inputs to and output from each of the service units.

6. The network security simulation system as set forth in claim 1, further comprising a sample network storage unit for defining the target network instead of the network configuration unit.

7. The network security simulation system as set forth in 1 or claim 2, further comprising a sample network storage unit for defining the target network instead of the network configuration unit.
